(19) United States
(12) Patent Application Publication
(10) Pub. No.: US 2012/0253926 A1
(43) Pub. Date: Oct. 4, 2012

(54) SELECTIVE DELIVERY OF CONTENT ITEMS

(75) Inventors: Kai Chen, Burlingame, CA (US); Scott S. Benson, Sunnyvale, CA (US); Jun Yang, San Jose, CA (US); Anurag Agarwal, Sunnyvale, CA (US); Scott Gilpin, Denver, CO (US); Fan Zhang, Fair Lawn, NJ (US); Sheng Ma, Fair Lawn, NJ (US)

(73) Assignee: GOOGLE INC., Mountain View, CA (US)

(21) Appl. No.: 13/077,253

(22) Filed: Mar. 31, 2011

(51) Int. Cl. G06Q 30/00

(52) U.S. Cl. 705/14.49; 705/14.4

(57) ABSTRACT

Systems, methods, and computer programs encoded on a computer-readable storage medium for allocating a minimum number of impressions to a content item in order to satisfy a delivery goal for the content item during a certain period of time are described. In some implementations, a satisfaction index (SI) for each content item can be used. The SI is a metric that reflects the degree to which a content selection service is on pace to meet a delivery goal for a content item within some period. The SI can be used to compare the number of impressions that have been allocated to the content item thus far in a period to the delivery or allocation goal for the content item in the period. A content selection service may determine scores for impression allocations based on both an estimate of value and the SI for a candidate content item in order to balance the goals of meeting delivery goals and optimizing impression inventory value.

### TECHNICAL FIELD

The subject matter of this application is generally related to the selection and display of online content.

### BACKGROUND

The Internet provides access to a wide variety of resources. For example, video and/or audio files, as well as web pages for particular subjects or particular news articles, are accessible over the Internet. Access to these resources presents opportunities for content (e.g., advertisements) to be provided with the resources. The pairing of content with requested resources can generate value. For example, a web page can include content slots in which advertisements or other content can be presented. These content slots can be defined in the web page or defined for presentation with a web page, for example, in a pop-up window.

Content slots can be allocated to buyers based on agreements entered into by publishers of online resources and buyers, where the agreement requires that publisher allocate to the buyer at least a threshold number of content slots over a specified period. For example, a publisher can agree, for a fee, to allocate at least 1000 of its available content slots to a buyer that has paid the publisher $10. In turn, the publisher's content slots can be allocated to the buyer over the specified period until 1000 content slots have been allocated to the buyer. A publisher may enter multiple agreements committing content slots to different buyers. Buyers may have many different content items that they wish to pair with resources.

### SUMMARY

Systems, methods, and computer programs encoded on a computer-readable storage medium for allocating a minimum number of impressions to a content item in order to satisfy a delivery goal for the content item during a certain period of time are described. In some implementations, to allocate a minimum number of impressions to a content item to satisfy a delivery goal for the content item during a certain period of time, a satisfaction index (SI) for each content item can be used. The SI is a metric that reflects the degree to which a content selection service is on pace to meet a delivery goal for a content item within some period. The SI can be used to compare the number of impressions that have been allocated to the content item thus far in a period to the delivery or allocation goal for the content item in the period. A content selection service may determine scores for impression allocations based on both an estimate of value and the SI for a candidate content item in order to balance the goals of meeting delivery goals and optimizing impression inventory value.

In some implementations, a method can be used that includes identifying a plurality of priority levels each associated with one or more candidate content items; receiving a request to present a content item for an ad campaign of an entity including receiving campaign information associated with the entity; identifying one or more targeting criteria associated with the request; identifying one or more eligible content items from the one or more candidate content items that meet the one or more identified targeting criteria; and serving, in response to the request, the one or more identified eligible content items based on the plurality of priority levels.

In some implementations, a method can be used that includes identifying one or more ad groups each associated with an ad campaign; determining a first delivery goal for each ad group; determining a second delivery goal by allocating the first delivery goal in proportion to traffic forecast; and serving one or more content items in the one or more ad groups based on the second delivery goal.

In some implementations, a system can be used that includes a database storing one or more candidate content items; and an optimizer configured to: identify a plurality of priority levels each associated with the one or more candidate content items; receive a request to present a content item for an ad campaign of an entity, the request including campaign information associated with the entity; identify one or more targeting criteria associated with the request; identify one or more eligible content items from the one or more candidate content items that meet the one or more identified targeting criteria; and serve, in response to the request, the one or more identified eligible content items based on the plurality of priority level.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for selective delivery of content.

FIG. 2 is a block diagram of an example optimized content selector.

FIG. 3 is a flow diagram of an example process for selecting content based on priority alone.

FIG. 4 is a flow diagram of an example process for using local and global decisions to select content.

FIG. 5 is a flow diagram of an example process for serving content items using priority levels.

FIG. 6 is a flow diagram of an example process for serving content items using delivery goals.

FIG. 7 is block diagram of an example computer system that can be used to implement the methods, systems and processes described in this disclosure.

Like reference numbers and designations in the various drawings indicate like elements.

### DETAILED DESCRIPTION

Selection of a content item for presentation in response to a resource request is interchangeably referred to as allocation of an impression to the selected content item (e.g., an advertisement).

The value of a particular resource request to a resource provider may correspond to the value to the resource provider of the presentation of one or more content items to a user in response to the resource request. For example, a request for an online resource may correspond to opportunities for providing one or more content items to a user that initiated the request. An opportunity to pair a content item with other content in the requested resource and provide the content item to a user for presentation in response to the request may be referred to as a content slot or an impression. Thus, each resource request represents one or more impressions that may each be allocated to a content item (e.g., an advertisement) that is selected to be provided in response to the resource request. The value of allocating an impression to a particular content item may depend on how a user is likely to react to presentation of the content item in the context of the impression.

The value of an allocation may be estimated based on information about the impression and the content item. For example, relevant information about an impression may include information about other content in the requested resource (e.g., keywords), the time of the request, data about the user who made the request (e.g., cookies, geographic location, etc.), etc. A content allocation system may seek to allocate impressions to content items in a manner that maximizes the estimated value of the allocations. In some implementations, a score used for selection of content items may be based in part on an estimate of the value of allocating an impression to a content item.

When selecting online content items for display, the online content selection service can be enabled to reject candidates that have scores that fall below a certain threshold because those candidates are not sufficiently valuable or relevant to other content in a requested resource or are low quality and not likely to be interacted with by a user. In some implementations, the candidates are also evaluated with respect to the other candidate content items, such that the user can be presented with content items that together satisfy a predetermined measure of delivery quality or value.

In some implementations, an online content selection service seeks to allocate a minimum number of impressions to a content item in order to satisfy a delivery goal for the content item during a certain period of time. Because the value of an impression when paired with a content item with a delivery goal may be less than a value that could be achieved with alternative content items that could be allocated the impression, there may be a tradeoff between meeting delivery goals for particular content items and maximizing cumulative value of impression inventory. A satisfaction index (SI) for each content item may be defined as a metric that reflects the degree to which a content selection service is on pace to meet a delivery goal for a content item within some period. A SI typically compares the number of impressions that have been allocated to the content item thus far in a period to the delivery or allocation goal for the content item in the period. A content selection service may determine scores for impression allocations based on both an estimate of value and an SI for a candidate content item in order to balance the goals of meeting delivery goals and optimizing impression inventory value.

In some implementations, a two-pass system can be used to select content, including a first pass using a local decision and a second pass using a global decision. By definition, the local decision can decide whether a content item should be considered based on how many times the content item has already been served, relative to its overall goal. The global decision is a form of a tie-breaker as between eligible items at a same priority level (i.e., when there are multiple content items that have passed the local decision).

A content item is any data that can be provided over a network. The processes described below are illustratively applied to content items that are advertisements provided in response to a request from an online resource, but the processes are also applicable to other content items provided over a network. Additionally, the description that follows describes content, such as advertisements, being selected by an optimized content selector that is implemented as an element of a content management system. However, the optimized content selector can be implemented as an independent system that communicates directly, or over a network, with the content management system or another data processing apparatus.

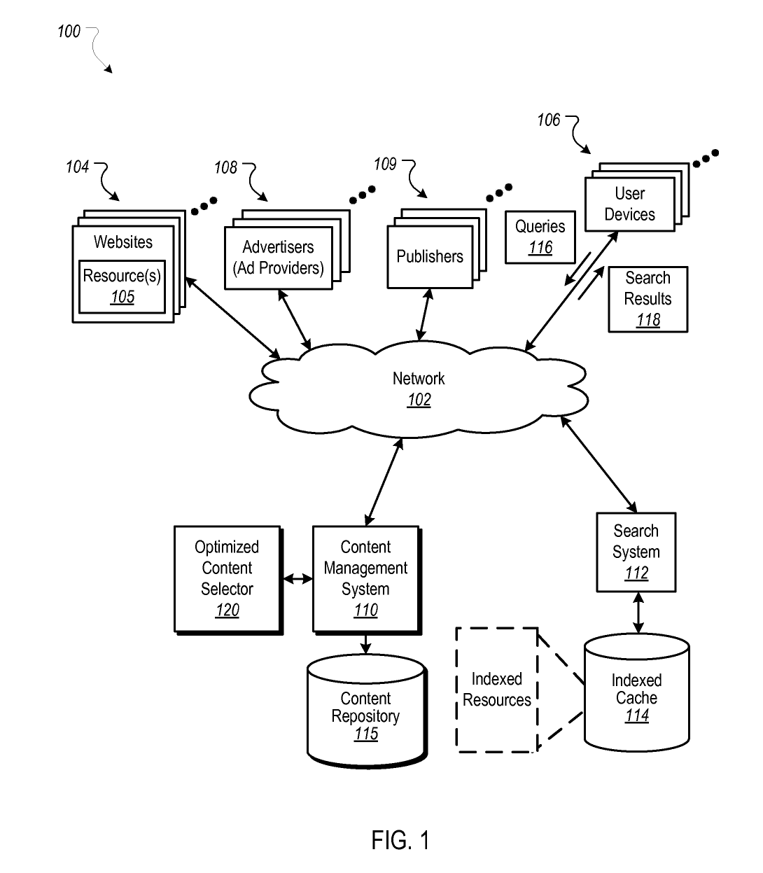

FIG. 1 is a block diagram of an example online environment 100 in which a content management system 110 manages content delivery services and an optimized content selector 120 optimizes the selection of the content. The example environment 100 includes a network 102 such as a local area network (LAN), wide area network (WAN), the Internet, or a combination thereof. The network 102 connects websites 104, user devices 106, content providers (e.g., advertisers 108), and the content management system 110. The example environment 100 may include many thousands of websites 104, user devices 106, and advertisers 108.

A website 104 includes one or more resources 105 associated with a domain name and hosted by one or more servers. An example website is a collection of webpages formatted in hypertext markup language (HTML) that can contain text, images, multimedia content, and programming elements, e.g., scripts. Each website 104 is maintained by a publisher, e.g., an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few examples. The resources can include content, e.g., words, phrases, images and sounds that may include embedded information (such as meta-information in hyperlinks) and/or embedded instructions (such as JavaScript scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which advertisements or other content can be presented. These specified portions of the resource or user display are referred to as slots, advertisement slots or impressions.

A request for content can be delivered to the content management system 110, such as from a publisher who is seeking to fill a particular slot. The request can include characteristics of the slots that are to be filled. Characteristics can include a size of the slot, and/or media types that are available for presentation in the slot. Similarly, keywords or targeting information associated with the slot can also be provided with the request.

Based on data included in the request for content (e.g., advertisements), the content management system 110 can select content (e.g., advertisements) that are eligible to be provided in response to the request (“eligible advertisements”). For example, eligible advertisements can include advertisements having characteristics matching the characteristics of advertisement slots.

The number of impressions that a particular advertiser receives may vary based, in part, on actions of other advertisers. For example, other advertisers in an auction may increase their bids to values higher than that of the particular advertiser. In turn, advertisements provided by the other advertisers may be presented in the advertisements slots that are allocated through the auction. Thus, the number of impressions that the particular advertiser's advertisement(s) receives may be below a number of impressions that the particular advertiser desired. The particular advertiser may have to increase its bid, and potentially pay more money than originally budgeted, to receive the desired number of impressions.

Some advertisers prefer that the number of impressions allocated to their advertisement and the price paid for the number of impressions be more predictable than the predictability provided by an auction. An advertiser can increase the likelihood that its advertisement receives a desired or specified number of impressions, for example, by entering into an agreement with a publisher, where the agreement requires the publisher to provide at least a threshold number of impressions (e.g., 1,000 impressions) for the advertisement over a specified period (e.g., one week). In turn, the advertiser, publisher, or both parties can provide data to the content management system 110 that enables the content management system 110 to facilitate satisfaction of the agreement.

For example, the advertiser can upload an advertisement and authorize the content management system 110 to provide the advertisement in response to advertisement requests corresponding to the publisher's website. Similarly, the publisher can provide the content management system 110 with data representing the specified time period as well as the threshold number of impressions that the publisher has agreed to allocate to the advertisement over the specified time period.

To facilitate allocation of advertisements according to the terms of an agreement between two parties, the content management system 110 may include the optimized content selector 120 that can optimize the selection and delivery of content from a content repository 115 that contains available content that can be served in response to a content request. For example, optimized content selector 120 can deliver a target number of impressions of a content item under varying rates of available inventory to maximize the effectiveness of the content item. In some implementations, the optimized content selector 120 can include one or more algorithms for managing the delivery rate that can lead to a smoother delivery of target impressions while selecting those impressions that maximize the content item's effectiveness. The algorithm(s) can use, for example, a controller (e.g., a proportion-integral-derivative controller as will be discussed in greater detail below) to set the fraction of available traffic on which the content should be delivered. In some implementations, the algorithm(s) can further use this fraction to select the most (or more) effective impressions. In some implementations, the controller can use a feedback loop to steer the delivery of content items close to its planned goal during the course of the delivery. For example, the controller can slow down the delivery when it is ahead of schedule and speed up the delivery when it is behind schedule. In a steady state, the delivery can be close to the schedule. In some implementations, the controller can also stabilize the delivery of content when there is a change in the environment, e.g., a spike of traffic due to unforeseen reasons. In some implementations, the controller can keep the delivery on schedule, and not deviate from the schedule.

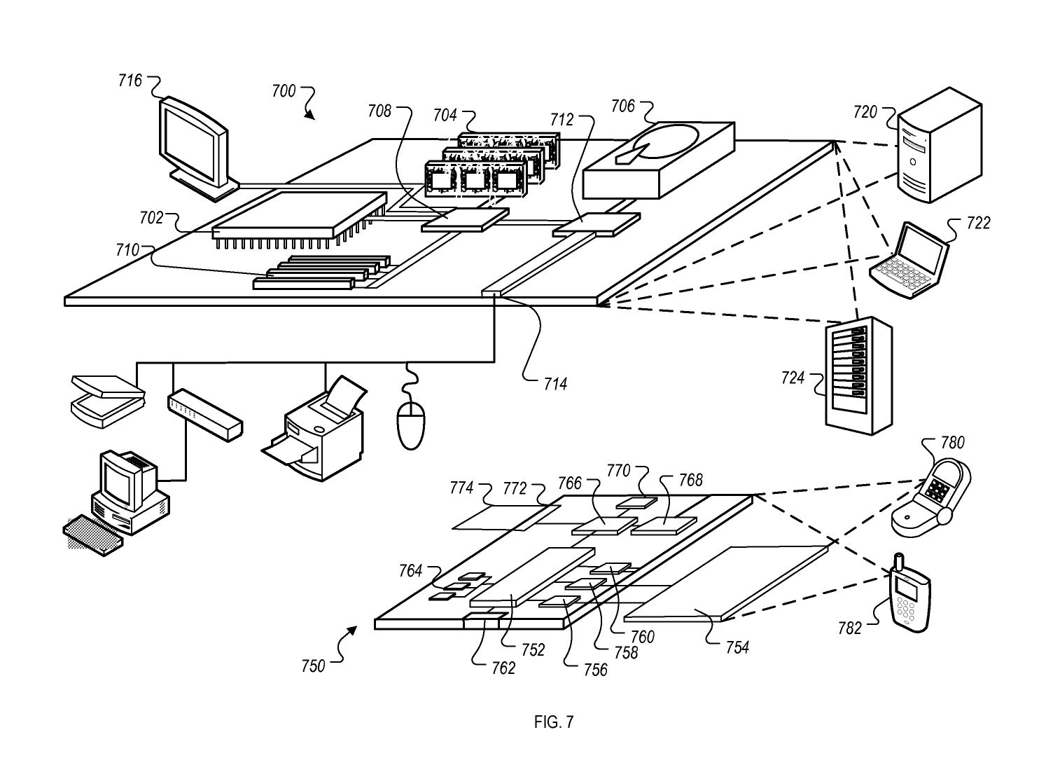

The optimized content selector 120 may be implemented as software that is executed on a processing apparatus, such as the computer system described in FIG. 7.

### Optimized Content Selector

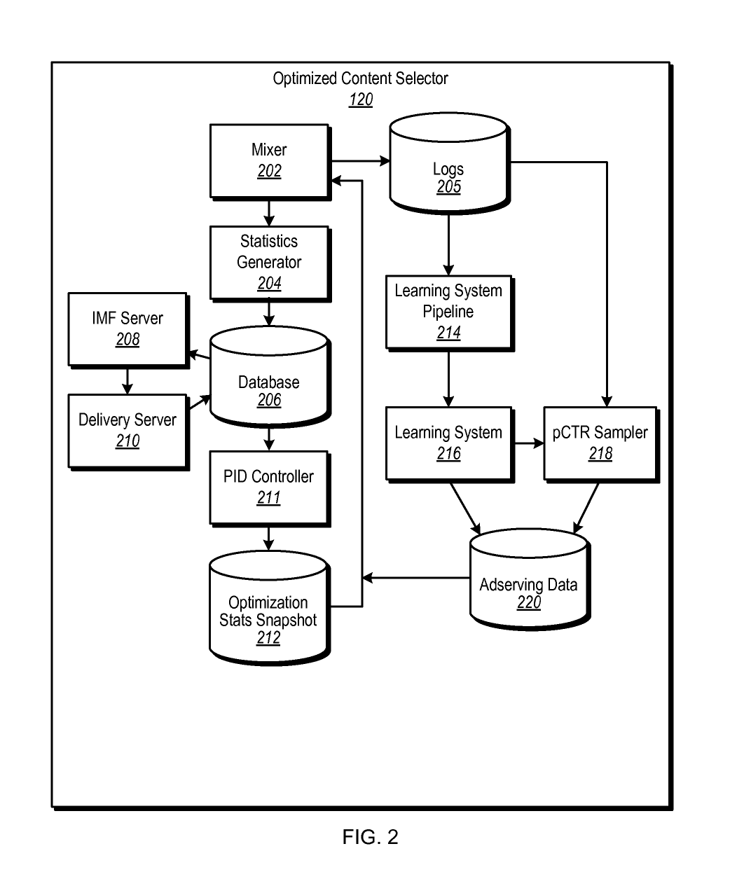

FIG. 2 is a block diagram showing example details for the optimized content selector 120. The entities in the diagram and the arrows between the entities can represent a process by which content is selected in an optimized way. However, this should not be construed as limiting, as other methods for achieving optimization also are contemplated.

As shown in FIG. 2, the optimized content selector 120 can include a content mixer 202. The content mixer 202 can be used to filter content items that: 1) have already been shown on the page; 2) have reached their frequency cap for a particular user; 3) are excluded by an exclusion constraint from some other content item; and/or 4) are excluded by a road-blocking constraint from some other content item (e.g., the other content item forces a particular content item to show up in this slot). In some implementations, the content mixer 202 can also filter content items whose targeting criteria do not match the request.

The optimized content selector 120 can also include a statistics generator 204 for evaluating content logs 205 as the logs are generated, and exporting data to statistics tables stored in a database 206, which can then be loaded with content stored in the content repository 115. The statistics generator 204, in some implementations, can run a map reduction (e.g., daily map reduction) over the data gathered by the statistics generator 204.

The database 206 can store information for candidate content items that can be served. Example information stored in the database 206 can include, without limitation, serving goals (e.g., hourly goals, daily goals, weekly goals, etc.) for each content item, statistics for past impressions, and parameters (e.g., priorities, content sponsor-specified serving strategies, throttling parameters, etc.) that are associated with each content item. In some implementations, throttling parameters can be used to increase the likelihood of serving content items (e.g., ads), e.g., in an ad campaign that is currently under budget.

As discussed previously, the content-selection process can consider a satisfaction index (SI) for each content item that is a metric of impressions that have occurred in relation to the delivery goals for the content item. In some implementations, the optimized content selector 120 can include an inventory management and forecasting (IMF) server 208 and a delivery server 210 to compute the satisfaction index (SI) for each content item. For example, the IMF server 208 can read data from an IMF system and set delivery goals (e.g., hourly delivery goals) for each content item (e.g., ads in an ad group). The IMF server 208 can compute a first set of goals associated with a first time period (e.g., daily goals) by allocating the traffic across all the days of an associated campaign (e.g., front-loading according to a campaign budget's front-loading parameter). Goals associated with a second time period (e.g., hourly goals) can then be set by allocating the first set of goals to one or more increments associated with the second time period (e.g., each hour of the day in proportion to the hourly traffic forecast). The goals associated with the second time period (e.g., the hourly goals) can then be stored in the database 206. In some implementations, SIs can be computed using clicks or conversions instead of, or in addition to, impressions.

In some implementations, hourly goals can be used to affect serving of content items shown throughout the day. In some implementations, the IMF server 208 can compute the SI from statistics of the previously served content and regularly distribute the information in real-time or with an expected update delay (e.g., 30 minutes). In some implementations, where real-time updates are desired, the optimized content selector 120 can include a budget server to compute the SI.

In some implementations, for some publishers, the SI can be computed without using IMF inputs. For example, for ad groups with unreliable traffic forecasting from the IMF server the optimized content selector 120 can use a fall-back estimate of traffic (e.g., hourly traffic). For example, the hourly traffic forecast can be identical to the actual traffic from the previous day, or the same day of the week in a previous week (or month). In some implementations, more sophisticated blending can be used to produce the forecast. In some implementations, the fall-back estimate can be implemented by having the delivery server 208 write the actual traffic data to a data store (e.g., the database 206), which can then be read directly by the delivery server 210. In some implementations, the delivery server 210 can receive forecasting from the IMF Server 208, perform fall-back forecasting whenever necessary, compute daily and hourly goals, and write the statistics to the database 206.

The optimization statistics snapshot 212 can store data representing a content item's delivery goal and the projected traffic pattern accessed and/or computed at regular intervals (or on demand). For example, the computations can use information provided by the delivery server 210. Statistics included in the optimization statistics snapshot 212 can include, for example, the SI for a content item. The information from the optimization statistics snapshot 212 can be fed back into the optimized content selector 120 (e.g., to the content mixer 202) for subsequent data modeling.

The learning system pipeline 214 can sample information from the logs 205 and provide the sampled information to the learning system 216. At regular intervals, for example, the learning system 216 can predict the click-through rate (CTR) for each content item, resulting in a predicted CTR (pCTR). Further, the learning system 216 (or some other system, module or component) can compute a pCTR percentile (PP), which can indicate whether the pCTR is relatively high or low for a particular content item. The information can be stored in an ad serving data store 220 or some other data store. In some implementations, the pCTR sampler can produce a distribution of the historical pCTRs for each content item. The distribution can be part of the ad serving data 220 which can be provided to the mixer 202. The learning system 216 can produce a model that can be used to predict pCTRs. The model can be part of the ad serving data 220. The model can be provided to the mixer 202 which can use the model to make pCTR predictions. Then, the mixer 202 can use the pCTR distribution data to derive the pCTR percentiles.

### Inputs for Selecting Content Items

In some implementations, the process of selecting a content item or items for presentation at a particular time can employ various selection criteria (e.g., delivery type, priority level, targeting criteria, etc.) in addition to the data available from the content repository 115 and the database 206. In some implementation, the selection criteria can include, for example, a satisfaction index (SI), predicted click-through rates (pCTRs), pCTR percentiles (PPs), and eCPM (estimated cost-per-1000-impressions). In some implementations, thresholds based on fraction of traffic can also be used as selection criteria.

In some implementations, the satisfaction index (SI) is a metric that can indicate a content item's serving state, e.g., the number of impressions shown relative to its target. By convention, an SI of 1000 can mean that the content item is exactly on schedule. The SI can be computed by comparing, for example, the impressions delivered on a current day to the number of content items that should be delivered according to the content item's delivery goal and the projected traffic pattern. In some implementations, the SI can be computed at regular intervals, such as hourly or more frequently.

In some implementations, in order to minimize fluctuations in the SI at, for example, various time in a given day (e.g., at the beginning of the day where traffic might be usually light and during the normal business hours where traffic might be heavy), the daily SI can be linearly blended with the SI from a previous day. For example, two SI values can be computed with one representing the current day and another representing the previous day. The SI value representing the current day (SI_{1day}) can be used to measure the SI since the start of the current day. The other SI value representing the previous day (SI_{2day}) can be used to measure the SI before the end of the previous day. Other part(s) of the day also can be used for the SI value representing the current day and SI value representing the previous day. In some implementations, the two SI values can then be linearly blended according to a fraction F of the current day that has elapsed, e.g., at time F (in [0, 1]), where the upper limit value of 1 represents 100% of a 24-hour period as given by [1]:

Blended SI=F*SI_{1day}+(1−F)*SI_{2day} [1]

As shown in [1], the blended SI value allows the SI to be computed using information from two days. For example, if the SI is computed on a Tuesday morning at 6 am, or 25% through the current day of Tuesday, then F is 0.25 and can be multiplied by SI_{1day} to compute Tuesday's portion of the blended SI. In this example, 1-F yields a value of 0.75 (1-0.25), representing 75% of Monday's traffic). Then, the value of 0.75 and can be multiplied by SI_{2day} to account for Monday's portion of the blended SI.

In some implementations, blending can employ information from a day that is not the previous day. For example, a different day (e.g., a previous weekday, or a day one week earlier) can be used as the “previous” day (SI_{2day}) if the actual previous day is not suitable for blending purposes. This can be the case, for example, where the previous day is a Sunday or a holiday that has different targeting, or day-part targeting is used (e.g., for content that appear only on a specific day such as only on Tuesday or only on Thursday).

In some implementations, if no forecasting data is available for computing goals, then the delivery goal can be spread evenly over the lifetime of the content item. In this case, each day can be front-loaded using a campaign budget front-loading parameter. In some implementations, if the content item is behind schedule, then the delivery goal can be modified to try to front-load more delivery of the content item in order to catch up on the delivery schedule. Some implementations can use a base front-loading parameter which can be adjusted, for example, according to whether the content item is on schedule or not. Then, a lifetime SI can be computed based on this daily delivery goal.

As discussed previously, the learning system 216 can invoke the mixer 202 to predict the click-through rate (CTR) for each content item, resulting in a predicted CTR (pCTR). In some implementations, the learning system 216 can use publisher-specific information in obtaining the pCTR. In some implementations, for content items that are not click-tracked so that these content items do not have a meaningful pCTR, the pCTR can be omitted from the selection process.

The pCTR percentile (PP), which indicates whether the pCTR is relatively high or low for the particular content item, can be expressed as a number between 0.0 and 1.0 (e.g., or any numerical range that expresses the relationship of the current pCTR to the pCTR over all of the other possible requests where the content item can be shown). Higher PP value can correspond to a higher pCTR relative to the complete set of pCTR so that a value near 1.0 can indicate that the request is one of the best possible requests for the content item. In some implementations, the PP can be estimated using a distribution that can be computed, for example, twice per day (e.g., or any number of times per day) by taking a random sample of requests from the logs (e.g., the logs 205) over, for example, the past 24 hours. For content items that are not click-tracked, or content items that are too new (e.g., ads that use day-part targeting to run on only certain days of the week) that may not have a meaningful PP, the PP can be omitted from the selection process.

In some implementations, the goal for delivery of a content item can be weighted (e.g., as a percentage of impressions). In some implementations, the goal for delivery of a content item can be an absolute goal. As a result, a content item can have a goal selected from (and characterized by) any goal from the set of weighted, absolute, unlimited goals.

In some implementations and as discussed above, priority levels can also be used in selecting a content item. In some implementations, a default priority level for content items can be assigned a certain value (e.g., 12), where lower values can represent higher priority levels. In some implementations, content items with a low priority can be selected after exhausting content items with a higher priority. Similarly, higher-priority content items can be selected first ahead of other low priority content items.

In some implementations, a remnant bucket that includes content items (e.g., remnant ads that are candidates for being served in an ad slot) having a remnant priority level also can be used. For example, remnant content items can be candidate content items for filling a block that may otherwise be wasted if not filled by a high(er)-bidding publisher. In some implementations, the remnant priority level can be set at a default priority level but can be overridden by publishers.

In some implementations, absolute-goal content items can be set for delivery using one of a plurality of (e.g., three) delivery schedules based on the average delivery goal (e.g., total goal/number of days) of the respective content item. For example, an “as-fast-as-possible” delivery schedule can be uncapped. In this case, if a content item matches an ad request and has budget remaining in the ad campaign, the selection process can refrain from selecting a lower-priority level content item in its place. If desired, other implementations can use more, fewer or different delivery schedules than those described above.

### Basic Serving Algorithm

In some implementations, the content management system 110 can execute a serving algorithm for controlling the order in which the content items are served. In some implementations, the serving algorithm can consider all content items in strict priority level order. For example, the serving algorithm can determine if any content items are available within a certain priority level. If at least one content item is available in that priority level, the serving algorithm can select one within that priority level for presentation. Otherwise, the serving algorithm can move on to the next priority level and locate a suitable content item to serve from that priority level. In some implementations, priority level overrides can be used, such as through optimization by selecting a lower-priority level content item that appears to be well-matched to a search query or ad request.

The serving algorithm, in some implementations, can apply various constraints to available content items during the selection process. For example, using one constraint, the content repository 115 can return only those content items for which the targeting criteria are met. As another example, using another constraint, a budget server can filter content items that are over a designated budget, or ahead of a predetermined delivery curve for a given day. As yet another example, the mixer 205 can filter content items that: 1) have already been shown in the ad slot; 2) have reached the frequency cap for a particular user; 3) are excluded by an exclusion constraint from one or more other content items; and/or 4) are excluded by a road-blocking constraint from some other content item (e.g., the other content item forces a particular content item to show up in this ad slot).

In some implementations, a budget server delivery curve can be set by the following equation [2]:

T*B*F̂K [2]

where T is the daily delivery target, B is a budget-limit constant having a value of one or greater, F is the fraction of the day that has passed so far, and K is a throttling parameter having a value of less than one. In some implementations, setting the throttling parameter K<1 can, for example, allow front-loaded delivery of the content item. In some implementations, a linear delivery curve may cause under-delivery due to traffic decreases near the end of the day. In some implementations, under-delivery can be remedied by setting B to 1.0 and K to 0.2. For example, when F is 0.5 (e.g., exactly in the middle of a day) and K is 0.2, then F̂K=0.87 which means that delivery allows 87% of the total budget to be consumed at this point. By comparison, if a linear curve is used, delivery would have allowed only 50% of the total budget to be consumed at that point. In this way, equation [2] can be a safe-guarding mechanism where it can cut off content item-serving when delivery is occurring too fast by mistake, or when the content item has exhausted its budget towards the end of the day. In some implementations, equation [2] may be only loosely coupled with the other algorithms described in this document. As discussed above, different types of content items (e.g., weighted, absolute goal, unlimited) can be served in different ways. In some implementations, various restrictions can be imposed including: 1) at non-remnant priority levels, weighted content items can take priority over absolute goal content items; and 2) at remnant priority levels, goal content items (weighted and absolute) can take priority over unlimited content items.

In some implementations, if there are one or more eligible content items at a particular priority level, then a two-pass algorithm can be applied. In the first pass, a local decision can be applied to each content item. The local decision, in some implementations, can determine whether the content item should be considered on a particular ad request. If more than one content item passes the local decision, a second pass can be used in which a global decision can be applied to select the winning content item for presentation. If no content item passes the local decision, the serving algorithm can move to the next priority level in which the foregoing process can be repeated until a winning content item is selected. The local decision can decide whether a content item should be considered based on its threshold, e.g., the fraction of traffic to serve, which can be computed by the PID controller 211. If the content item is optimized, then in some implementations, the content item's pCTR can be used to make that decision. For a local decision without optimization, this content item simply would randomly “pass” the local decision 20% of the time. With optimization, the content item would pass the local decision when the pCTR percentile is greater than 80%, which should happen on 20% of the requests. The global decision is a form of a tie-breaker as between eligible items at a same priority level (i.e., when there are multiple content items that have passed the local decision). There can be many different possible tie-breaking algorithms. For example, if a content item has a threshold of 0.8, this means the system estimates it needs to serve the content item on 20% (i.e., 1.0-0.8) of the requests to meet its goal.

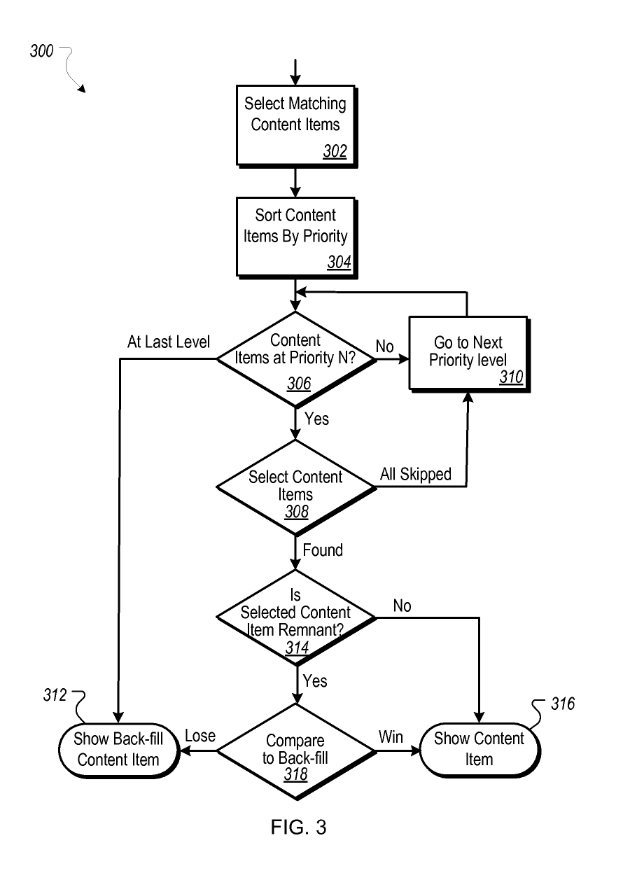

FIG. 3 is a flow diagram of an example process 300 for selecting content items based on priority levels. The process 300 can be performed, for example, by the content management system 110 and the optimized content selector 120, and for clarity of presentation, the description that follows uses the content management system 110 and the optimized content selector 120 as the basis of examples for describing the process 300. However, another system or combination of devices and systems also can be used to perform the process 300.

Referring to FIG. 3, at 302, candidate content items can be selected that match a content item request. For example, the content items that are selected can include content items identified by the content management system 110. Identification of the content items can be responsive to the request for content items. The request for content items can include characteristics of the ad slot that are defined for which content is desired.

At 304, content items can be sorted by priority. For example, content items can be sorted into groups by priority level, where zero or more content items can be sorted into any one particular priority level group.

At 306, processing of content items can begin including a determination that is made as to whether any content items exist at a current priority level N, e.g., starting at the highest priority level. For example, if the highest priority number is 1, then a determination can be made as to whether any content items have a priority level of 1.

If a content item exists at the current priority level, then content items at that priority can be considered (308), applying the local decision to all the elements found at 306; if this succeeds, the process 300 resumes at 314, otherwise process 300 resumes at 310 and goes on to the next priority level. As an example, a content item that has the current priority level of 1 can be used for subsequent steps of process 300. If no content items exist at the current priority level of 1, then process 300 can move on to the next priority level at 310. The process continues until one or more eligible content items at a priority level have been identified, starting at the highest priority levels first.

If no content item can be identified (306) at any of the priority levels, then a back-fill content item can be selected (312). For example, if process 300 determines that no content items exist up to a default priority level (e.g., 12), then the optimized content selector 120 can select a back-fill content item. For example, a back-fill content item can be a content item that the publisher can choose to receive from another third-party ad-server to backfill the slot. This can happen, for example, when there is no other content item to serve in that slot. In some implementations, back-fill ads can be set up with a low priority so that they do not trump the delivery of other content items in the inventory.

At 314, based on the selected content item at the current priority, a determination can be made as to whether the selected content item is a remnant content item. Whether an ad is a remnant content item or not depends on the content item itself. Content items with a priority lower than a certain threshold are considered remnant. For example, the database 206 can identify the type of the selected content item, e.g., whether it is a remnant content item or some other type of content item.

At 316, if the selected content item is not a remnant content item, then the selected content item can be designated as eligible to be served. At 318, if the selected content item is a remnant content item, then the selected content item can be compared to a back-fill content item. For example, the optimized content selector 120 can compare the selected content item with the back-fill content item to determine which content item is a better candidate to be served. Selection criteria can include which content item is paying more, e.g., has a higher CPM, or whether the third-party ad-server can provide another content item that will produce more revenue (e.g., that is paying a higher CPM).

If the selected content item is better than a back-fill content item, then the selected content item can be designated as an eligible content item to be served. Otherwise, the back-fill content item can be shown instead of the selected content item. Checking against back-fill content items can potentially increase a publisher's revenue. Remnant content items (which are the only ones that can be replaced with back-fill content items) are typically not under a delivery guarantee, and thus can be replaced with higher-paying content items, except for higher-priority content items, as doing so can jeopardize delivery goals.

An optimized selection process, described below, can further use a local decision and a global decision. In some implementations, remnant ads can compete in the selection process based on CPM rather than scheduling considerations.

### The Local Decision

As discussed above, each content item can be assigned a threshold, for example, between 0 and 1, that controls how often the content item passes the local decision. In some implementations, a threshold of 0 can mean that the content item is always accepted. Similarly, a threshold of 1 can mean that the content item is never accepted. In some implementations, if the content item is not optimized, then a random or pseudo random number (e.g., between 0, 1) can be assigned, and the content item can be accepted if the random number is above the threshold. In some implementations, if the content item is optimized, then the pCTR percentile of the content item can be computed, and the content item can be accepted if the percentile is above the threshold.

As an example, a content item that has an as-fast-as-possible delivery schedule can be accepted in all cases. If an optimized content item does not have a meaningful pCTR percentile (e.g., which can happen if the content item is new or if the content item is one that is not click-tracked), then a random number can be assigned for comparison against the threshold.

The threshold, in some implementations, can be controlled by the proportion-integral-derivative (PID) controller 211 based on concepts from control theory. The PID controller 211 can run, for example, once per hour as part of an optimization statistics extractor. In some implementations, the PID controller 211 can use the previous threshold and the SI to compute a newly updated threshold, targeting an SI of 1000 (e.g., to reduce the threshold if the content item is behind schedule, or to increase the threshold if the content item is ahead of schedule).

### The Global Decision

In some implementations, for non-optimized content items, content item-serving can be performed based on the computed SI. In some implementations, each behind-schedule content item (e.g., items with SI<1000) can be given a weight of [3]:

1+(1000−SI)*0.01, [3]

while ahead-of-schedule content items can be given a constant weight of 1.0. Then, a content item can be selected randomly according to these weights. As a result, content items that are farther behind schedule are more likely to be served, while less behind-schedule content items are more likely to be served than ahead-of-schedule content items. For example, a content item with an SI of 900 can be twice as likely to be served as an on-schedule content item. If all content items are ahead of schedule, in some implementations, one content item can be selected at random. In some implementations, it can be advantageous to have a weight function that is substantially continuous. This is because a highly discontinuous function can lead to spiky delivery as content items oscillate below and above the threshold.

In some implementations, for optimized content items, each content item can be assigned a weight of [4]:

(1−threshold)/(1−percentile) [4]

where threshold can be capped at 1.0, with percentile less than 1.0. In so doing, a higher weight can be assigned to content items that are further behind schedule (e.g., content items having a lower threshold) as well as content items for which an ad request is particularly effective (e.g., content items having a high percentile). In some implementations, one content item can be selected randomly according to these weights. As mentioned above, the PID controller 211 can set the threshold, for example, as low as −9.0, which can give additional weight to behind-schedule content items in the global decision.

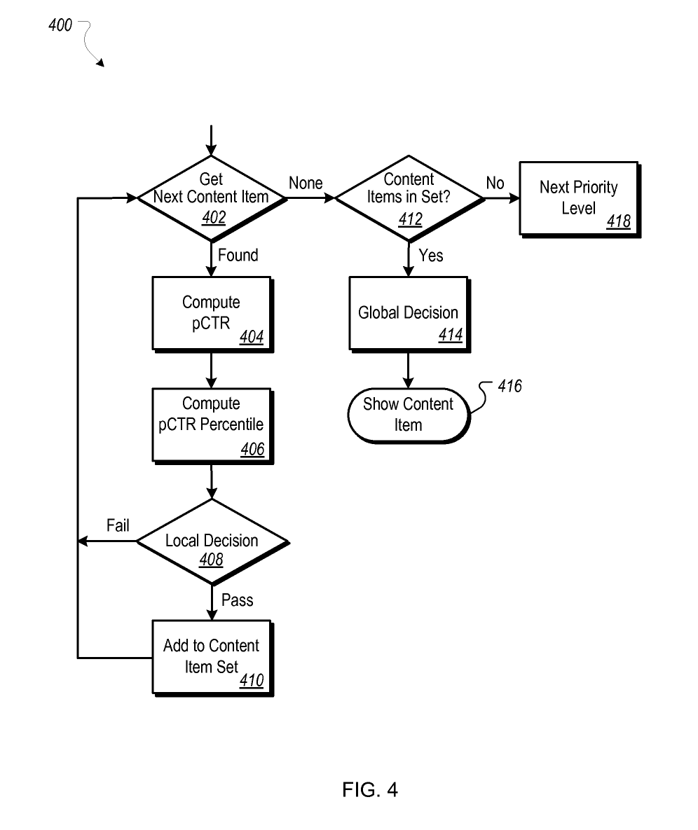

FIG. 4 is a flow diagram of an example process 400 for using local and global decisions to select content items. The process 400 can be performed, for example, by the content management system 110 and the optimized content selector 120, and for clarity of presentation, the description that follows uses the content management system 110 and the optimized content selector 120 as the basis of examples for describing the process 400. However, another system or combination of devices and systems also can be used to perform the process 400.

At 402, a next content item can be obtained. For example, the content item can be one of several content items in a group of content items having the same priority level.

At 404, if a content item in a content item group is found, then the content item's pCTR is computed. At 406, the content item's pCTR percentile also can be computed. For example, the content item's pCTR and the content item's pCTR percentile can be computed as described above.

At 408, a local decision can be performed. At 410, if the content item passes the local decision, then the content item can be added to the accepted content item set. For example, as described above, the content item's threshold, which can be set between 0 and 1, can control how often the content item passes the local decision. The threshold can be controlled by the PID controller 211. If the content item fails the local decision, then the next content item can be obtained until all content items in the candidate set are exhausted.

At 412, if no content items remain to be processed, then a determination can be made as to whether any content items are in the accepted content item set. For example, the content items that remain in the accepted content item set can include those that have passed the local decision. However, if no content items have passed the local decision, the accepted content item set is empty. In some implementations, if a publisher enables back-filling (e.g., ads) for a content item slot, then a back-fill ad can be requested from a third-party ad-server.

At 414, if more than one content item is found in the accepted content item set, then a global decision can be performed on the content items in the accepted content item set. For example, the global decision can be performed to select the winning content item among those in the accepted content item set.

At 416, the winning content item can be presented. At 418, if no content items are found in the accepted content item set, then the algorithm can move to the next priority level. For example, the next priority level selected can be the next lower priority level (e.g., one priority number higher) than the current set.

Process 400 allows the optimized content selector 120 to select a content item not only using priorities, but also based on local and global decisions. In some implementations, process 400 can be executed in any other logical sequence that can provide similar results. In some implementations, additional process steps can be added, or an expanded number of priority levels can be used, in order to optimize the selection of the content item by process 400.

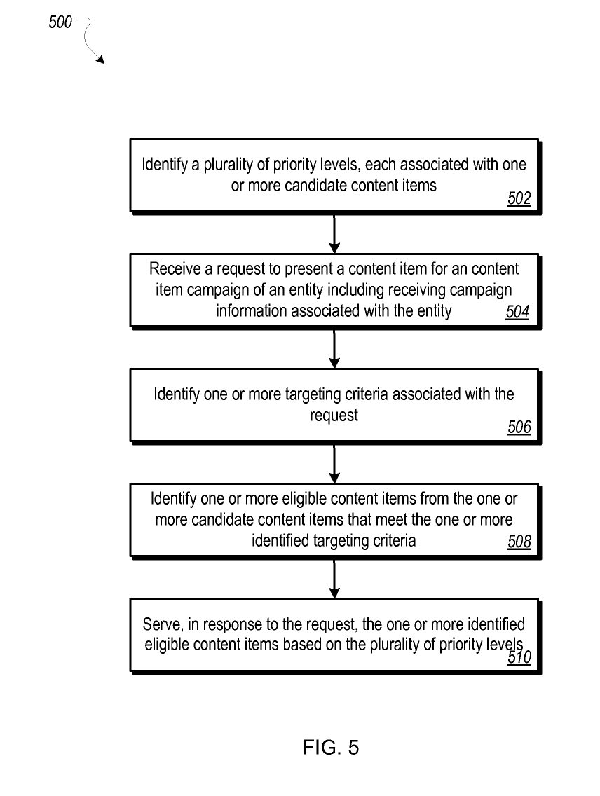

FIG. 5 is a flow diagram of an example process 500 for serving content items using priority levels. The content management system 110, for example, can perform the process 500. For example, the content items served using the process 500 can be content items (e.g., ads) that are provided to the user devices 106, such as in response to available ad slots on a visiting web page or other application.

At 502, a plurality of priority levels can be identified, where each level can be associated with one or more candidate content items. For example, referring to the process described previously with respect to FIG. 3, priorities can be identified for content items. For example, if the content items are ads, then each of the ads can be assigned with a priority level by which priority-based selections can be made. In some implementations, the priority levels can be represented with values, where the highest value corresponds to the lowest priority level. The candidate content items, for example, can be available in the content repository 115 described earlier with reference to FIG. 1. In some implementations, identifying the plurality of priority levels can include identifying several priorities including, for example, a first priority level and a second priority level lower than the first priority level.

At 504, a request can be received to present a content item. For example, referring to FIG. 1, the content management system 110 can receive a request for content. If, for example, the request is an ad request, then the content management system 110 can receive campaign information related to the campaign (e.g., campaign budget, campaign type, etc.). In some implementations, the request can be for a non-ad content item, such as text, images, audio and/or video that is not ad-related.

At 506, one or more targeting criteria associated with the request can be identified. For example, if the request is for an ad, then targeting criteria can include keywords and delivery schedule. In some implementations, identifying the one or more targeting criteria can include a current time-of-day on which the request is received. The current time-of-day can include an exact time (e.g., 10 AM) at which the request is received, or a general time frame (e.g., morning, afternoon, or evening).

At 508, one or more eligible content items from the one or more candidate content items that meet the one or more identified targeting criteria can be identified. Continuing the current example, the content management system 110 can identify eligible ads, e.g., ads that match the one or more targeting criteria. The eligible ads can be identified from ads in the content repository 115. If time-of-day information is included with the targeting criteria, then the time-of-day information can be used to identify eligible content items (e.g., ads) that can be delivered to match the content item's delivery goal and the projected traffic pattern associated with the ad campaign.

In some implementations, identifying the one or more eligible content items (e.g., ads) can include performing a local decision on each candidate ad at the first priority level to determine the one or more eligible content items (e.g., ads). For example, the local decision, as described earlier with reference to FIG. 3, can be used to select an eligible content item (e.g., an ad) based on the content item's serving state, where items that are behind schedule are more likely to be selected.

In some implementations, if no eligible content item is determined after performing the local decision, then a local decision can be performed on each candidate content item at the second priority level to determine the one or more eligible content items. For example, the local decision can start at the highest priority level content item and keep working down, until one or more eligible content items are selected at that or a lower priority level.

In some implementations, during the local decision, a threshold associated with each candidate content item can be identified, and a candidate ad can be determined to be an eligible content item. For example, when determining eligible content items, the content management system 110 can use the thresholds described earlier with reference to FIG. 3.

In some implementations, identifying the threshold can include identifying a current threshold and updating the current threshold using a previous threshold. For example, the content management system 110 can determine what a content item's current threshold is, and modify the threshold.

In some implementations, the threshold associated with a candidate content item can be set based on whether the candidate content item is ahead of or behind a predetermined serving schedule. For example, if the number of impressions for an ad is less than the scheduled number for the ad (e.g., as defined by the ad campaign), then the content management system 110 can set the threshold so that the ad is more likely to be selected.

In some implementations, updating the current threshold can include decreasing the threshold if the content item is behind schedule, and increasing the threshold if the content item is ahead of schedule. Continuing with the current example, the content management system 110 can update the threshold in order to speed up (or slow down) the delivery of ads as an attempt to get the number of impressions to match the delivery schedule defined by the ad campaign.

In some implementations, if more than one eligible content item is determined after performing the local decision, then a global decision can be performed on each of the one or more eligible ads resulting from the local decision. For example, as described above with reference to FIG. 3, the global decision can serve as the tie-breaker for a set of eligible ads that passed the local decision and have the same priority.

In response to the request, the one or more identified eligible content items are served based on the plurality of priority levels (510). For example, referring to FIG. 1, the content management system 110 can provide the one or more eligible content items for display on the user devices 106.

In some implementations, serving the one or more eligible ads can include serving one or more eligible content items (e.g., ads) associated with the first priority level prior to serving one or more eligible content items (e.g., ads) associated with the second priority level. For example, a regular ad having high priority level can be served before (or instead of) a remnant ad having a lower priority level.

In some implementations, more than one identified eligible content item can be served. The served content items can include one or more eligible content items with a lower threshold than one or more eligible content items with a higher threshold.

In some implementations, when identifying the one or more eligible content items, a weight can be assigned to each candidate content item based on the one or more identified targeting criteria; and the one or more eligible content items can be identified based on the assigned weight. For example, the content management system 110 can assign different weights to different content items in order to affect the identification of eligible content items (e.g., to select non-remnant ads over remnant ads).

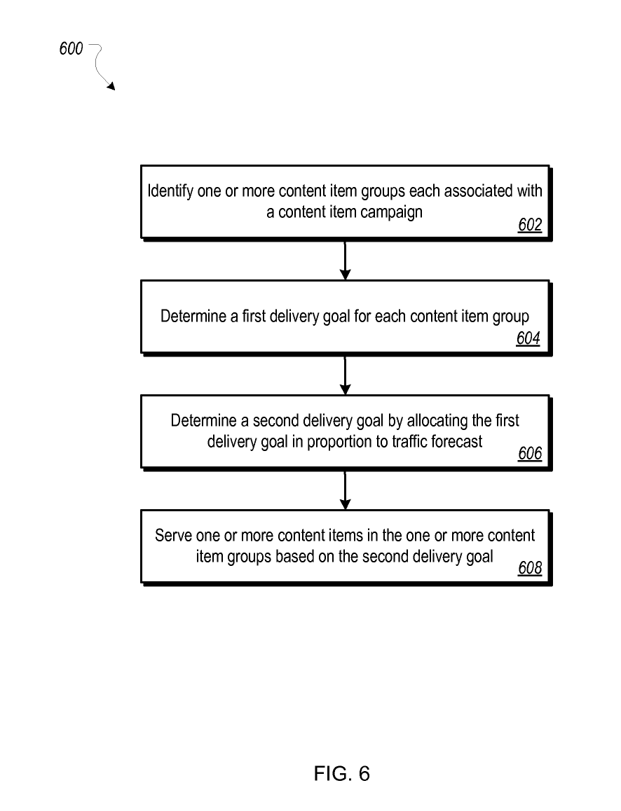

FIG. 6 is a flow diagram of an example process 600 for serving content items using delivery goals. The process 600 can be performed, for example, by the content management system 110, and for clarity of presentation, the description that follows uses the content management system 110 as the basis of examples for describing the process 300. However, another system or combination of devices and systems also can be used to perform the process 600.

At 602, one or more content item groups, each associated with a content item campaign, can be identified. For example, for content items that are ads, the content management system 110 can identify one or more content item groups.

At 604, a first delivery goal for each content item group can be determined. For example, the delivery goal can identify a target number of times (e.g., a goal) that a content item is to be served (e.g., the number of planned impressions of an ad). The target number of times can be associated with a time period, such as an hour, day or some other time period.

In some implementations, determining the first delivery goal can include determining a daily goal by allocating traffic across one or more days on which the content item campaign is active. For example, an ad group can be allocated across one or more days in order to determine, for example, a delivery goal of a specific number of content item impressions per day.

At 606, a second delivery goal can be determined by allocating the first delivery goal in proportion to a traffic forecast. For example, if a delivery goal for an ad group is allocated to a traffic forecast associated with ad impressions for ads in the ad group, then a second delivery goal can be determined from the resulting allocation.

In some implementations, the second delivery goal can include allocating the daily goal to each hour of a day on which the content item campaign is active in proportion to an hourly traffic forecast. For example, the second delivery goal determined in this way can have an hour-by-hour number of planned impressions for ads in the ad campaign.

In some implementations, an hourly goal can be determined based on the allocation. For example, a goal number of impressions per hour for an ad can be determined.

At 608, one or more content items can be served in the one or more content item groups based on the first delivery goal. Continuing the same example, one or more ads can be served using the second delivery goal.

In some implementations, the process 600 can also include comparing an actual hourly delivery with the hourly goal and determining a satisfaction index based on the comparison. For example, the actual number of ad impressions can be counted for an ad group during an hour-long time period. The count can be compared to the hourly goal in order to compute a satisfaction index, as described earlier with respect to FIG. 3.

In some implementations, determining the satisfaction index can include determining a first satisfaction index associated with a previous day and a second satisfaction index associated with a current day. For example, satisfaction indexes can be computed for adjacent or successive time periods, e.g., successive days. In some implementations, determining the satisfaction index can use multiple hours.

In some implementations, serving the one or more content items can include serving the one or more content items based on the satisfaction index. For example, the number of impressions for a content item can be behind schedule, as indicated by the satisfaction index as described above with reference to FIG. 3. Based on this information, content items can be selected so that content items having a lower satisfaction index, for example, can be selected, which can lead to an actual delivery that is closer to goal.

### Generic Computing System

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
identifying a plurality of priority levels each associated with one or more candidate content items;
receiving a request to present a content item for an ad campaign of an entity including receiving campaign information associated with the entity;
identifying one or more targeting criteria associated with the request;
identifying one or more eligible content items from the one or more candidate content items that meet the one or more identified targeting criteria; and
serving, in response to the request, the one or more identified eligible content items based on the plurality of priority levels.

2. The method of claim 1, wherein identifying the one or more targeting criteria includes identifying at least one of a budget constraint associated with the ad campaign or a current time of day on which the request is received.

3. The method of claim 1, wherein:
identifying the plurality of priority levels includes identifying a first priority level and a second priority level lower than the first priority level; and
serving the one or more eligible content items includes serving one or more eligible content items associated with the first priority level prior to serving one or more eligible content items associated with the second priority level.

4. The method of claim 1, wherein:
identifying the plurality of priority levels includes identifying a first priority level and a second priority level; and
identifying the one or more eligible content items includes performing a local decision on each candidate content item at the first priority level to identify the one or more eligible content items.

5. The method of claim 4, wherein, if more than one eligible content item is identified after performing the local decision, the method further comprising:
performing a global decision on each of the one or more identified eligible content items resulting from the local decision.

6. The method of claim 4, wherein, if no eligible content item is identified after performing the local decision, the method further comprising:
performing a local decision on each candidate content item at the second priority level to determine the one or more eligible content items.

7. The method of claim 4, wherein performing the local decision includes:
identifying a threshold associated with each candidate content item; and
determining a candidate content item to be an eligible content item if the threshold associated with the candidate content item is met.

8. The method of claim 7, further comprising setting the threshold associated with a candidate content item based on whether the candidate content item is ahead of or behind a predetermined serving schedule.

9. The method of claim 8, wherein updating the current threshold includes decreasing the threshold if the content item is behind schedule and increasing the threshold if the content item is ahead of schedule.

10. The method of claim 7, wherein serving the one or more identified eligible content items includes serving more than one identified eligible content item including serving one or more eligible content items with a lower threshold than one or more eligible content items with a higher threshold.

11. The method of claim 7, wherein identifying the threshold includes identifying a current threshold, the method further comprising:
updating the current threshold using a previous threshold and a proportion-integral-derivative controller.

12. The method of claim 1, wherein identifying the one or more eligible content items:
assigning a weight to each candidate content item based on the one or more identified targeting criteria; and
identifying the one or more eligible content items based on the assigned weight.

13. The method of claim 12, wherein assigning the weight includes assigning the weight based on a threshold.

14. The method of claim 13, further comprising:
determining the first threshold based on whether a candidate content item is ahead of or behind a predetermined serving schedule; and
determining the second threshold using a relationship of a current predicted click through rate and a predicted click through rate over one or more previous ad requests for which the candidate content item is eligible to be served.

15. A method comprising:
identifying one or more ad groups each associated with an ad campaign;
determining a first delivery goal for each ad group;
determining a second delivery goal by allocating the first delivery goal in proportion to traffic forecast; and
serving one or more content items in the one or more ad groups based on the second delivery goal.

16. The method of claim 15, wherein determining the first delivery goal includes determining a daily goal by allocating traffic across one or more days on which the ad campaign is active.

17. The method of claim 16, wherein determining the second delivery goal includes allocating the daily goal to each hour of a day on which the ad campaign is active in proportion to an hourly traffic forecast.

18. The method of claim 17, wherein determining the second delivery goal includes determining an hourly goal based on the allocation.

19. The method of claim 18, further comprising:
comparing an actual hourly delivery with the hourly goal; and
determining a satisfaction index based on the comparison.

20. The method of claim 19, wherein determining the satisfaction index includes determining a first satisfaction index associated with a previous day and a second satisfaction index associated with a current day.

21. The method of claim 19, wherein serving the one or more content items includes serving the one or more content items based on the satisfaction index.

22. A system comprising:
a database storing one or more candidate content items; and
an optimizer configured to:
identify a plurality of priority levels each associated with the one or more candidate content items;
receive a request to present a content item for an ad campaign of an entity, the request including campaign information associated with the entity;
identify one or more targeting criteria associated with the request;
identify one or more eligible content items from the one or more candidate content items that meet the one or more identified targeting criteria; and
serve, in response to the request, the one or more identified eligible content items based on the plurality of priority level.
